(19) United States
(12) Patent Application Publication
(10) Pub. No.: US 2009/0048725 A1
(43) Pub. Date: Feb. 19, 2009

(54) TRAIN CREW MANAGEMENT AND SECURITY SYSTEM

(75) Inventors: Mark Edward Kane, Orange Park, FL (US); James Francis Shockley, Orange Park, FL (US)

Correspondence Address: DLA PIPER LLP (US);ATTN: PATENT GROUP, 500 8th Street, NW, WASHINGTON, DC, 20004-2131, US

(73) Assignee: QUANTUM ENGINEERING, INC., Orange Park, FL (US)

(21) Appl. No.: 11/839,580

(22) Filed: Aug. 16, 2007

(51) Int. Cl. G06F 19/00

(52) U.S. Cl. 701/19

(57) ABSTRACT

A locomotive security system (LSS) is provided. The locomotive security system includes a processor located on a locomotive; an I/O device connected to the processor; and a data storage medium reading device connected to the processor. In some embodiments, the I/O device can be configured to obtain personal information from an operator and communicate the personal information to the processor. Additionally, the data medium reading device can be configured to read data stored on a portable data storage medium.

### BACKGROUND

Locomotives are used in a variety of ways. For example, locomotives are used with freight trains for shipping goods. Additionally, locomotives are used with passenger trains for transporting passengers. As such, locomotives are very important to society.

Unfortunately, conventional locomotives do not have any type of security system. In fact, these locomotives do not even require a key to start the locomotive. Thus, any passerby could enter the locomotive and operate it. As a result, conventional locomotives are susceptible to being operated by unauthorized personnel such as vandals who “joyride” on the locomotives.

### BRIEF SUMMARY

A locomotive security system (LSS) is provided. In an exemplary embodiment, an operator inserts a portable data storage medium into a data storage medium reading device and inputs through an input/output (I/O) device personal information, which enables the locomotive to operate in a regular manner.

In yet another embodiment, when the operator leaves the locomotive, and removes the portable data storage medium, the locomotive is automatically disabled.

In one aspect, the LSS can be used on a single locomotive or in a consist with other locomotives that have or do not have an LSS.

In another aspect, the LSS can be used as a stand alone system or can be incorporated into an existing alertness system.

In still another aspect, the LSS can be integrated with an operator's alertness device.

In another embodiment, a key is used in place of the portable data storage medium.

### BRIEF DESCRIPTION OF THE DRAWINGS

A more complete appreciation of the invention and many of the attendant features and advantages thereof will be readily obtained as the same become better understood by reference to the following detailed description when considered in connection with the accompanying drawings, wherein:

FIG. 1 is a block diagram of an exemplary embodiment of the present invention;

FIG. 2 is a flowchart illustrating operations of the system of FIG. 1;

FIG. 3 is a flowchart illustrating a method for responding to an alertness device penalty according to another exemplary embodiment of the present invention;

FIG. 4 is a system diagram of an exemplary embodiment of the present invention; and

FIG. 5 is a system diagram of another exemplary embodiment of the present invention.

### DETAILED DESCRIPTION

Exemplary embodiments will be discussed with reference to locomotive security systems. Specific details, such as types of signals, are set forth in order to provide a thorough understanding of the exemplary embodiments. The exemplary embodiments discussed herein should not be understood to be limiting. Furthermore, for ease of understanding, certain method steps are delineated as separate steps; however, these steps should not be construed as necessarily distinct nor order dependent in their performance.

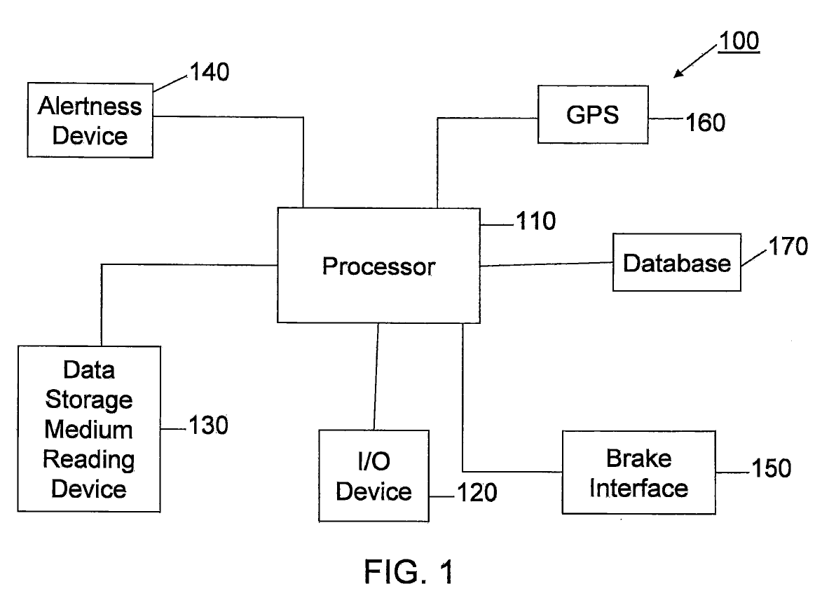

A locomotive security system 100 in accordance with an exemplary embodiment is illustrated in FIG. 1. The system 100 includes a processor 110, an input/output (I/O) device 120, a data storage medium reading device 130, an alertness device 140, and a brake interface 150. The system 100 may include other components described in detail throughout the specification.

The processor 110 may be a microprocessor or may be implemented using discrete components. The processor 110 is responsible for implementing the logical operations discussed in detail below. In an exemplary embodiment, the processor is located on a locomotive.

The I/O device 120 is connected to the processor 110. The I/O device 120 is configured to obtain personal information from an operator and communicate the information to the processor 110. Personal information may include a personal identification number (PIN), a voice sample, an eye retina scan, a fingerprint, or any information that is personal to an individual. An operator can include any individual who is authorized to operate the locomotive.

The data storage medium reading device 130 is also connected to the processor 110. In one exemplary embodiment, the data storage medium reading device 130 may be configured to read data stored on a portable data storage medium. The portable data storage medium can include a data watch card, a smart card, a universal serial bus (USB) storage device, a flash drive, or any non-volatile medium used for storing data. Further, the portable data storage medium may be a reusable storage medium. In another exemplary embodiment, the data storage medium reading device 130 may be configured to write the data to the portable data storage medium.

The data may include trip identification information, crew identification information, event recorder information, engineer certification and federal railroad administration (FRA) compliance data or any other information that is capable of being stored on the portable data storage medium. Trip identification information can be mileage information, the numbers of hours worked in a shift by an employee, arbitraries information, or any information used in traveling to a destination. Event recorder information refers to the information stored by a solid state recorder (SSR).

Crew identification information refers to the personal information of a crew member authorized to be onboard the locomotive such as a PIN, a voice sample, an eye retina scan, a fingerprint, or any information that is personal to an individual. For example, an operator of the locomotive may use a PIN, a fingerprint, etc., in conjunction with a portable data storage medium to enable a locomotive to move in a specified direction.

Mileage information refers to the number of miles to a location traveled by a locomotive. For example, a locomotive may travel 100 miles to a destination. For every 100 miles, the locomotive may need to be serviced for maintainence and/or refueled. Thus, the recording of mileage traveled by a locomotive is helpful in allowing the locomotive to operate effectively.

In an exemplary embodiment, an LSS may be used in connection with an engineer certification system that complies with FRA rules. For example, a console associated with the LSS may be used to automatically certify engineers using recorded data stored on the portable data storage medium to check against a golden run for rules compliance and fuel usage. (A golden run is a recording made during a run over a particular section of track in which the train is operated perfectly.) Further, identification of the operator, who was authorized to make a trip in compliance with FRA rules, may be determined.

In various exemplary embodiments, the data may be used in an electronic crew management system. This electronic crew management system may be integrated with an LSS and configured to communicate the data to a server. For example, an operator boards the locomotive and inserts the portable data storage medium in the console of the locomotive. Next, the operator enters an alphanumeric code on the console. At the end of the trip, the operator removes the portable data storage medium and goes to a sign-off location. At the sign off location, the operator places the portable data storage medium onto a base station computer. At this time, the operator may add any data to the portable data storage medium at the base station computer.

After the data is added at the base station computer, the processor 110 of the LSS on a locomotive may communicate crew payroll information stored on a portable data storage medium, including arbitraries information, to a server located at a center for monitoring operations of the locomotives. In an exemplary embodiment, the payroll information is transmitted to a mainframe. In another exemplary embodiment, the data is transmitted to a playback station. This information includes payroll information as well as SSR information. This information creates a nexus between SSR information and the location and train symbol information for reviewing the SSR information.

The information may be communicated using various forms of wireless communications such as radio frequency communications, microwave communications, or any wireless communications scheme known in the art. In various exemplary embodiments, the information is uploaded automatically to the servers at the center. The updated information may include the most recent trip information. As such, the operator does not need to determine where the trip information came from.

Arbitraries information refers to information pertaining to an individual who has performed a task not within his employment responsibilities and who receives additional compensation for performing the task. For example, a train crew operator may be owed additional compensation for remaining onboard a train past a certain milepost or after a certain distance has been traveled by the train.

The alertness device 140 is also connected to the processor 110. Alertness devices are well known in the art. Some examples of alertness devices, sometimes referred to as “alerters,” can be found in U.S. Pat. Nos. 6,903,658 and 5,392,030, which are more advanced than the alerters commonly used on board locomotives today. In one exemplary embodiment, the alertness device 140 may be configured to solicit a response from the operator. Further, the alertness device 140 can communicate to the processor 110 and inform the processor 110 of the response. As such, the processor 110 may be configured to disable the locomotive if no response is received. Additionally, the processor 110 may be configured to prevent the locomotive from operating until the data stored on the portable data storage medium and the personal information of the operator is re-verified.

The brake interface 150 can be connected to the processor 110. In an exemplary embodiment, the brake interface 150 may be configured to operate a brake on the locomotive in response to a control signal from the processor 110. Alternatively, the brake interface 150 can be configured to allow the controller 110 to activate and control the brakes when necessary to slow and/or stop the locomotive. Brake interfaces are well known in the art and will not be discussed in further detail herein.

Referring now back to FIG. 1, also connected to the processor 110 is a positioning system 160. The positioning system 160 is a GPS receiver in exemplary embodiments. The GPS receiver can be of any type, including a differential GPS, or DGPS, receiver. Other types of positioning systems 160, such as inertial navigation systems (INSs), Loran systems, and wheel/axle tachometers can also be used. Such positioning systems are well known in the art and will not be discussed in further detail herein. (As used herein, the term “positioning system” refers to the portion of a positioning system that is commonly located on a mobile vehicle, which may or may not comprise the entire system. Thus, for example, in connection with a global positioning system, the term “positioning system” as used herein refers to a GPS receiver and does not include the satellites that are used to transmit information to the GPS receiver.)

A database 170 is also connected to the controller 110. The database 170 preferably comprises a non-volatile memory such as a hard disk, flash memory, CD-ROM or other storage device, on which track data and the locations of wayside signal devices is stored. Other types of memory, including volatile memory, may also be used. The track data preferably also includes positions of switches, grade crossings, stations and anything else of which an operator is required to or should be cognizant of. The track data may also include information concerning the direction and grade of the track.

In some embodiments, the LSS is configured for operation in a consist. As is well known in the art, when conventional locomotives are operated in a consist, MU (multi-unit) jumpers between the locomotives are connected to allow operation of controls in any one locomotive to affect all locomotives (e.g., when an operator moves a throttle to a particular notch in any one locomotive of the consist, the propulsion system on each of the locomotives in the consist receives a signal as if the throttle in that locomotive were moved to the same notch.) In these embodiments, the LSSs on each locomotive are connected, preferably via a jumper on the same connector on which the MU jumpers are located. Each LSS will send a periodic message informing the other LSSs of its presence so that each LSS can determine when it is in a consist. When a first LSS in a consist has an operator successfully log in, and that first LSS has not previously received any notification of a successful login from any other LSS, the first LSS sends a message to the other LSSs in the consist notifying them that the first LSS has an operator successfully logged in and thus the first LSS is to be the lead LSS. The lead LSS will then allow the controls in that locomotive to be operated normally such that those controls will also control the other locomotives in the consist. The LSSs on all other locomotives in the consist (i.e., the trail LSSs) will allow remote operation of the controls from the lead locomotive but will prevent any local operation of the controls on the locomotive in which it is installed. The lead LSS will remain so until such time as the operator logs out, at which point the lead LSS will send a message to the other LSSs informing them that it is no longer the lead LSS. Any attempts by an operator to log in on a trail LSS will be ignored until such time as the connection between a trail LSS and the lead LSS is broken or a message from the lead LSS that it is no longer the lead LSS is received. In some embodiments, any attempt to operate the controls of a trail locomotive or log into an LSS on a trail locomotive will result in the generation of a penalty brake signal.

A trail locomotive can be added to a consist at any time. Upon detecting a new trail locomotive added to the consist, the lead LSS will transmit a message informing the trail LSS that the lead LSS is the lead, and the LSS on such a trail locomotive will automatically operate as a trail locomotive until such time as the connection between a trail LSS and the lead LSS is broken or a message from the lead LSS that it is no longer the lead LSS is received. As a result, additional locomotives may be added during the trip without any additional operations taking place.

The trail locomotive carrying the LSS can be anywhere in the consist. In one exemplary embodiment, the trail locomotive carrying the LSS can be next to the lead locomotive. Alternatively, the trail locomotive can be interspersed with locomotives without an LSS.

In various exemplary embodiments, the LSS can be disabled. For example, an operator may use his personal information and data stored on a portable data storage medium to render the LSS inoperative.

In another exemplary embodiment, the locomotive can be semi-operable for being towed in trail service but not fully-operable for loading. This towing locomotive feature can be used if the locomotive is defective. Alternatively, the towing feature can be used if the LSS is defective.

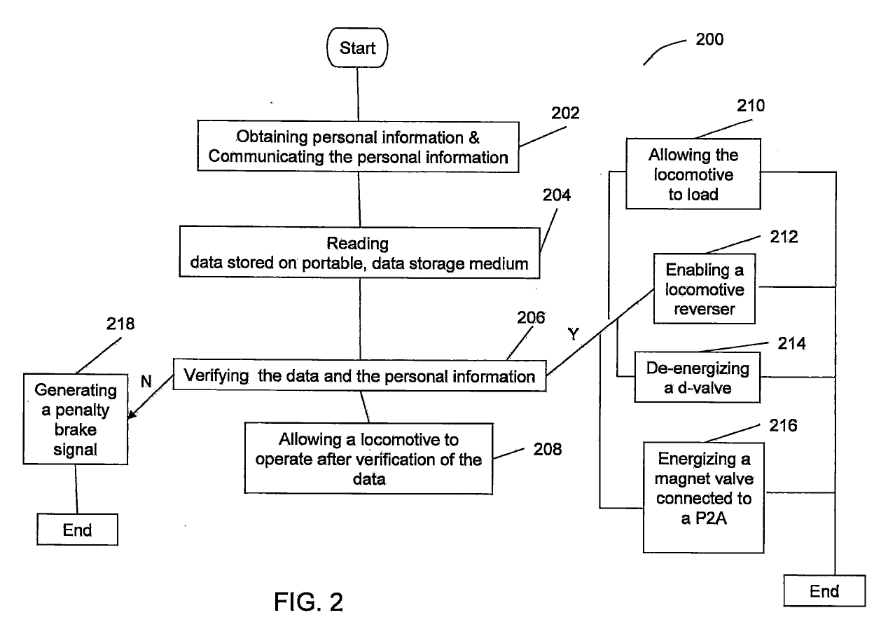

A flowchart 200 illustrating operation of the LSS system 100 is shown in FIG. 2. The process starts with the I/O device 120 obtaining personal information from an operator and communicating the personal information to the processor at a step 202. Next, the data storage medium reading device 130 reads data stored on a portable data storage medium at step 204. The processor 110 then verifies that the data and the personal information obtained from the operator are valid and that the data and personal information match at step 206. The processor 110 allows a locomotive to operate (i.e., move) after verification of the data corresponding to the portable data storage medium and the personal information at step 208.

In another exemplary embodiment, the processor 110 may be configured to receive a signal that indicates that the portable data storage medium has been removed from the data storage medium reading device. Further, the processor 110 disables the locomotive from being operative upon receipt of the signal.

If the data and the personal information obtained from the operator are valid, the processor 110 may be configured to perform any one or more of the following steps. The processor 110 allows the locomotive to load at step 210. The processor 110 enables a locomotive reverser at step 212. The processor 110 de-energizes a D-valve at step 214. The processor 110 energizes a magnet valve connected to a P2A at step 216. Alternatively, if the data and the personal information obtained from the operator are not valid, the processor 110 generates a penalty braking signal if an automatic brake is set in the release position at step 218.

In one embodiment, the magnet valve may be de-energized such that main reservoir air is transferred to a locomotive horn. In another embodiment, the magnet valve may be de-energized such that a J-1 relay valve is enabled to blow the locomotive horn. In yet another embodiment, the magnet valve may be de-energized such that brake cylinder pressure is applied to the locomotive brake.

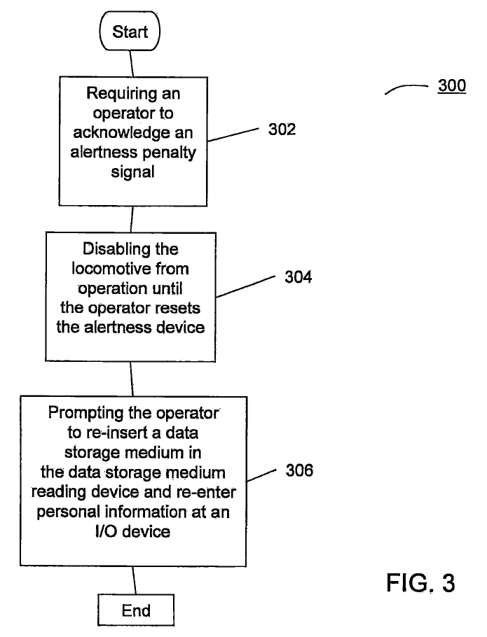

A flowchart 300 illustrating a method for responding to an alertness device penalty according to another exemplary embodiment is shown in FIG. 3. The process starts with the processor 110 requiring an operator to acknowledge an alertness penalty signal at step 302. Next, the processor 110 disables the locomotive from operation until the operator resets the alertness device at step 304. Thereafter, the processor 110 prompts the operator to re-insert a data storage medium in the data storage medium reading device and re-enter personal information at an I/O device at step 306.

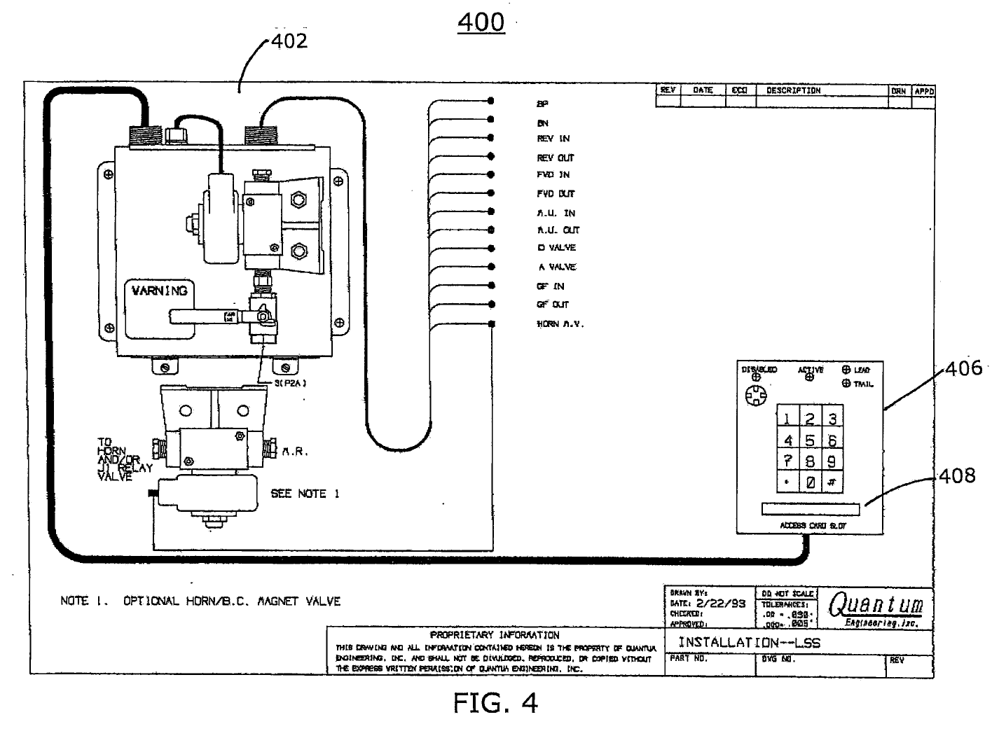

A system 400 illustrating an LSS 402 according to an exemplary embodiment is shown in FIG. 4. The system 400 for the LSS 402 includes a processor (not shown) that implements the logical operations; a key pad 404 that obtains a security code; and a card slot 406 that reads data stored on a portable data storage medium. The system 400 may operate in the manner described in FIG. 2. The system 400 may include other components described in detail throughout the specification.

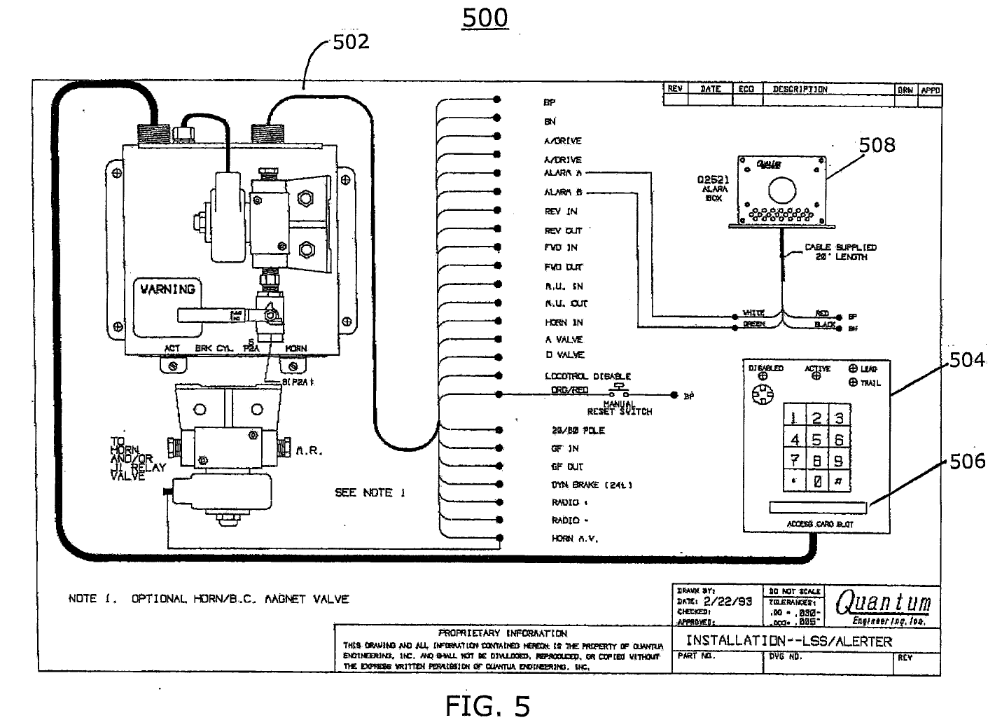

A system 500 illustrating an LSS 502 integrated with an alertness device 508 according to an exemplary embodiment is shown in FIG. 5. The system 500 for the LSS 502 includes a processor (not shown) that implements the logical operations; a key pad 504 that obtains a security code; a card slot 506 that reads data stored on a portable data storage medium; and an alertness device 508 that solicits a response from the operator. The system 500 may operate in the manner described in FIG. 2 and FIG. 3. The system 500 may include other components described in detail throughout the specification.

In another embodiment of the invention, a traditional mechanical key is used in place of the portable data storage medium. The key may be any type of mechanical key. It should be understood that such embodiments will require some type of personal data (e.g., biometric data or a PIN) from an operator in order to complete the log in process. In such embodiments, trip data and other data that was written to the portable data storage medium may be transmitted to a location off the train via a wireless link.

It will be apparent to those skilled in the art that numerous variations in addition to those discussed above are also possible. Therefore, while the invention has been described with respect to certain specific embodiments, it will be appreciated that many modifications and changes may be made by those skilled in the art without departing from the spirit of the invention. It is intended therefore, by the appended claims to cover all such modifications and changes that fall within the true spirit and scope of the invention.

Furthermore, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A locomotive security system comprising:
a processor located on a train;
an input/output (I/O) device connected to the processor, the I/O device being configured to obtain personal information from an operator and communicate the personal information to the processor;
a data storage medium reading device connected to the processor, the data medium reading device being configured to read data stored on a portable data storage medium;
wherein the processor is configured to perform the steps of:
verifying that the data and the personal information obtained from the operator match and that the operator is authorized to operate the locomotive; and
allowing a locomotive to operate after verification of the data corresponding to the portable data storage medium and the personal information.

2. The system of claim 1, wherein the processor is configured to receive a signal that indicates that the portable data storage medium has been removed from the data storage medium reading device and disable the locomotive from being operative in response to the signal.

3. The system of claim 1, wherein allowing a locomotive to operate further comprises at least one of the following steps:
allowing the locomotive to load;
enabling a locomotive reverser;
de-energizing a D-valve; and
energizing a magnet valve connected to a P2A.

4. The system of claim 1, further comprising:
generating a penalty braking signal if an automatic brake is set in the release position and the verification step has failed.

5. The system of claim 3, wherein the magnet valve is de-energized such that main reservoir air is transferred to a locomotive horn.

6. The system of claim 3, wherein the magnet valve is de-energized such that a J-1 relay valve is enabled to blow the horn.

7. The system of claim 3, wherein the magnet valve is de-energized such that brake cylinder pressure is applied to the locomotive brake.

8. The system of claim 1, wherein the personal information includes a voice sample.

9. The system of claim 1, wherein the personal information includes an eye retina scan.

10. The system of claim 1, wherein the personal information includes a fingerprint.

11. The system of claim 1, wherein the data is written to the data storage medium while the data storage medium is inserted into the data storage medium reading device.

12. The system of claim 1, wherein the data storage medium reading device is configured to write the data to the data storage medium.

13. The system of claim 1, wherein the data recorded on the data storage medium includes trip information.

14. The system of claim 1, wherein the trip information includes mileage information.

15. The system of claim 1, wherein the trip information includes hours worked by an employee information.

16. The system of claim 1, wherein the trip information includes arbitraries information.

17. The system of claim 1, further comprising:
a brake interface connected to the processor, the brake interface being configured to operate a brake on the locomotive in response to a control signal from the processor.

18. The system of claim 1, further comprising:
an alertness device connected to the processor, the alertness device being configured to solicit a response from the operator;
wherein the processor is configured to perform the steps of:
disabling the locomotive if no response received; and
preventing locomotive from operating after the disabling step until the data and personal information is re-verified.

19. A method for responding to an alertness device penalty comprising the steps of:
requiring an operator to acknowledge an alertness penalty signal;
disabling the locomotive from operation unless the operator resets the alertness device; and
prompting the operator to re-insert a data storage medium in the data storage medium reading device and re-enter personal information at an I/O device.

20. A method for allowing a locomotive to operate with a security system comprising:
obtaining personal information from an operator and communicating the personal information to a processor;
reading data stored on a portable data storage medium;
verifying that the data and the personal information obtained from the operator are valid and that the data and personal information match; and
allowing a locomotive to operate after verification of the data corresponding to the portable data storage medium and the personal information.

21. The method of claim 20, wherein the processor is configured to receive a signal that indicates that the portable data storage medium has been removed from the data storage medium reading device; and wherein the processor disables the locomotive from being operative upon receipt of the signal.

22. The method of claim 20, wherein verifying that the data and the personal information obtained from the operator are valid further comprises selecting at least one of the following steps:
allowing the locomotive to load;
enabling a locomotive reverser;
de-energizing a D-valve; and
energizing a magnet valve connected to a P2A.

23. The method of claim 20, further comprising:
generating a penalty braking signal if an automatic brake is set in the release position and the verification step has failed.

24. The method of claim 22, wherein the magnet valve is de-energized such that main reservoir air transferred to a locomotive horn.

25. The method of claim 22, wherein the magnet valve is de-energized such that a J-1 relay valve is enabled to blow the horn.

26. The method of claim 22, wherein the magnet valve is de-energized such that brake cylinder pressure is applied to the locomotive brake.

27. The method of claim 20, wherein the personal information includes a voice sample.

28. The method of claim 20, wherein the personal information includes an eye retina scan.

29. The method of claim 20, wherein the personal information includes a fingerprint.

30. The method of claim 20, wherein the data is written to the data storage medium while the data storage medium is inserted into the data storage medium reading device.

31. The method of claim 20, wherein the data storage medium reading device is configured to write the data to the data storage medium.

32. The method of claim 20, wherein the data recorded on the data storage medium includes trip information.

33. The method of claim 20, wherein the trip information includes mileage information.

34. The method of claim 20, wherein the trip information includes hours worked by an employee information.

35. The method of claim 20, wherein the trip information includes arbitraries information.

36. A locomotive security system comprising:
a processor located on a train;
an input/output (I/O) device connected to the processor, the I/O device being configured to obtain personal information from an operator and communicate the personal information to the processor;
a lock, the lock being configured to be openable by an operator with a mechanical key and transmit a signal to the processor indicative of an open state;
wherein the processor is configured to perform the steps of:
verifying that the personal information obtained from the operator corresponds to an operator that is authorized to operate the locomotive; and
allowing a locomotive to operate after verification of the personal information.
